(19) United States
(12) Patent Application Publication
(10) Pub. No.: US 2024/0331005 A1
(43) Pub. Date: Oct. 3, 2024

(54) METHOD AND SYSTEM FOR GENERATING ITEM SET RECOMMENDATIONS

(71) Applicant: ZEBRA TECHNOLOGIES CORPORATION, Lincolnshire, IL (US)

(72) Inventors: Sambuddha Saha, Burdwan (IN); Karthikeyan Nagarajan, Chennai (IN); Anil Ozdemir, Sheffield (GB)

(21) Appl. No.: 18/128,880

(22) Filed: Mar. 30, 2023

(51) Int. Cl. G06Q 30/0601; G06Q 10/087

(52) U.S. Cl. CPC G06Q 30/0631; G06Q 10/087

(57) ABSTRACT

A method includes: capturing, via a sensor of a mobile computing device, a first item identifier; determining, at the mobile computing device, whether the first item identifier matches one of a plurality of primary item identifiers; in response to determining that the first item identifier matches one of the primary item identifiers, providing input data to a classification model, the input data including the first item identifier; obtaining, via execution of the classification model, an item set identifier corresponding to an item set containing the first item identifier; and presenting the item set identifier at an output of the mobile computing device.

### BACKGROUND

Facilities such as grocers or other retailers may have inventories containing a wide variety of distinct items, which may be combined to form item sets, e.g., defining recipes for preparing food dishes in the case of a grocer. The number of distinct items at the facility, and/or the number of possible ways in which such items can be combined into item sets, may complicate the automated generation of recommended item sets for customers of such facilities.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for generating item set recommendations.

FIG. 2 is a diagram of certain internal components of a client device of FIG. 1.

FIG. 3 is a flowchart of a method for generating item set recommendations.

FIG. 4 is a diagram illustrating example item data in the system of FIG. 1.

FIG. 5 is a diagram illustrating an example performance of block 310 of the method of FIG. 3.

FIG. 6 is a diagram illustrating an example performance of blocks 310 to 325 of the method of FIG. 3.

FIG. 7 is a diagram illustrating an example performance of block 330 of the method of FIG. 3.

FIG. 8 is a diagram illustrating an example performance of block 340 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: capturing, via a sensor of a mobile computing device, a first item identifier; determining, at the mobile computing device, whether the first item identifier matches one of a plurality of primary item identifiers; in response to determining that the first item identifier matches one of the primary item identifiers, providing input data to a classification model, the input data including the first item identifier; obtaining, via execution of the classification model, an item set identifier corresponding to an item set containing the first item identifier; and presenting the item set identifier at an output of the mobile computing device.

Additional examples disclosed herein are directed to a computing device, comprising: a sensor; a display; and a processor configured to: capture, via the sensor, first item identifier; determine whether the first item identifier matches one of a plurality of primary item identifiers; in response to determining that the first item identifier matches one of the primary item identifiers, provide input data to a classification model, the input data including the first item identifier; obtain, via execution of the classification model, an item set identifier corresponding to an item set containing the first item identifier; and present the item set identifier at the display.

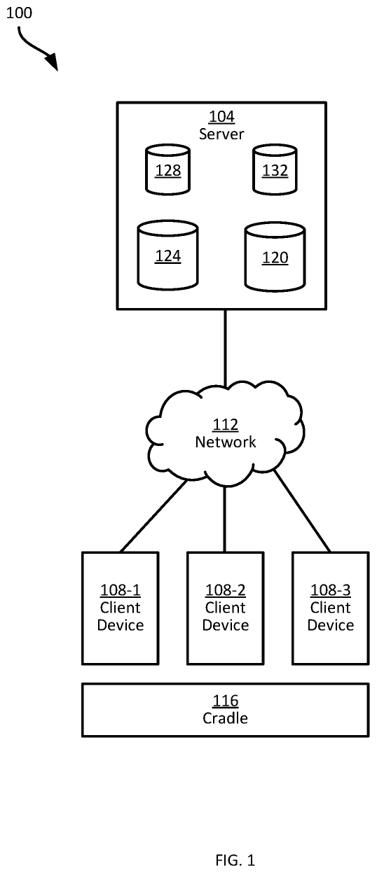

FIG. 1 illustrates a system 100 for assisting the retrieval of items in a facility such as a grocer or other retailer. Such facilities may house inventories containing thousands of distinct items, which may be combined in a significant number of item sets, e.g., to prepare a wide variety of dishes.

The variety of available items, and the variety of item sets in which those items may be combined, may complicate the retrieval of items from a facility by customers of the facility. For example, a customer may enter such a facility to retrieve and purchase a set of items for preparing a particular dish. The customer may, having retrieved some of the items in the set, discover that one of the remaining items of the set is out of stock. The customer may be unaware of a viable substitute for that item, and/or may be unaware of a different item set (e.g., for a different dish) that makes use of the items already retrieved. The customer may therefore, for example, abandon the retrieval of the item set and travel to a different facility. In other scenarios, the customer may employ a personal computing device such as a smartphone to search for alternative item sets, but those may also specify items that are not in stock at the facility.

The inventory of a facility such as a grocer, hardware store, or other facility where sets of items may be purchased for a common purpose (e.g., the preparation of a dish) can be tracked in a repository managed by a server deployed at or otherwise associated with the facility. The repository can be employed to generate automated item set recommendations for customers of the facility. However, the breadth of available items represented in such a repository, in combination with the wide variety of possible item sets that may be assembled from those items, can render the generation of recommendations prohibitively costly in terms of computational resources. Further, the variety of available items and possible item sets formed from those items can reduce the likelihood of a recommendation system generating output that would be acted on by the customer. In other words, even if the significant computational resources involved in generating automated item set recommendations were to be deployed, the resulting recommendations may be ignored by customers, yielding little or no return to the operator of the facility.

The system 100 implements various functionality to automatically generate recommended item sets based on detected customer activity, while mitigating the computational cost of generating such recommendations and/or increasing the accuracy of the recommendations (e.g., the likelihood of a customer making use of the recommendations). The system 100, as discussed below, improves the functioning of computing infrastructure hosting the previously mentioned repository by reducing the possible search space of items and item sets, using historical customer activity data and specially configured item set definitions.

The system 100 includes a server 104 in communication with a plurality of client devices 108-1, 108-2, and 108-3 (collectively referred to as the client devices 108, and generically referred to as a client device 108; this nomenclature may also be employed for other components herein), via a network 112 such as a suitable combination of local and wide-area networks. Although three client devices 108 are illustrated in FIG. 1, the system 100 can include greater numbers of client devices 108 in other examples. The client devices 108 can be implemented as mobile computers, e.g., having smartphone and/or tablet form factors.

The client devices 108 are deployed at a facility such as a grocer or other retailer. For example, the facility can contain a charging cradle 116 configured to support one or more of the client devices 108, e.g., near an entrance to the facility. Customers entering the facility can retrieve a client device 108 from the charging cradle 116, make use of the client device 108 while retrieving items for purchase in the facility, and return the client device 108 to the charging cradle 116 (or another charging cradle at an exit of the facility) following retrieval and purchase of the items. The client devices 108 implement various functionality to capture item identifiers as the customer retrieves items from the facility, and to present information to the customer, e.g., including further recommended items.

The server 104 can be deployed at the facility in some examples. In other examples, the server 104 can be deployed remotely from the facility, e.g., in a data center or the like, and communicatively connected with the client devices 108 within the facility. The server 104 stores a variety of data used in the generation of item set recommendations. For example, the server 104 can store an inventory database 120, representing the current inventory of the facility. The inventory database 120 can contain records for each item stocked by the facility, as well as data defining the stock level of the item (e.g., a number of units of a given item), the price of the item, and the like. The database 120 can contain a wide variety of item attributes for each item, including promotional price data (e.g., defining a reduced price, and a date range during which the reduced price applies), expiry data (e.g., defining a date at which one or more instances of an item are to be removed from shelving for disposal), and the like. The database 120 can also contain locations of the items within the facility, e.g., in the form of a planogram or other suitable data structure.

The server 104 can also store a repository 124 of item set definitions. In the context of a grocer, each item set definition can define a particular dish, and contains item identifiers for the ingredients (e.g., product names and/or stock-keeping unit (SKU) identifiers or the like) of that dish. The database 120, in other words, defines available items within the facility (e.g., thousands of distinct items stocked by the facility), and the repository 124 defines possible combinations of items. As noted earlier, both the number of items in the database 120, and the number of item sets in the repository 124, may be large. A given item retrieved by a customer, for example, may be present in hundreds of distinct item sets defined in the repository 124.

The server 104 also maintains a classification model 128. The classification model 128 is configured to accept input data containing one or more item identifiers, and to generate output data including one or more candidate item set identifiers. The candidate item set identifiers correspond to item sets from the repository 124. Each candidate item set contains the input item identifier(s), and may also contain additional item identifiers. The candidate item sets are selected from the larger number of item sets defined in the repository 124, based on the likelihood that a customer having retrieved the items identified in the input data to the model 128 will also retrieve the additional items in one or more of the candidate item sets. In other words, in the context of a grocer, the model 128 is configured to predict which dish the customer is most likely to be shopping for, based on the items the customer has already retrieved.

The model 128 can be implemented, for example, as any one or more of a Markov chain, a hidden Markov model (HMM), a recurrent neural network, a long short-term memory (LSTM) model, a gated recurrent unit (GRU) model, or the like. The model 128 can be trained using a plurality of input data sets, each input data set containing one or more item identifiers. Each input data set may also be labelled with an item set identifier (e.g., a dish name or other dish identifier, in this example), indicating the eventual set of items retrieved by a customer following the retrieval of the items identified in the input set. Via a suitable training process, the model 128 is constructed to accept further input data containing one or more item identifiers, and to predict the item set(s) most likely to be sought by a customer having already retrieved the items in the input set.

The server 104 can maintain a distinct model 128 for each facility, or for a geographical region containing more than one facility (e.g., if each facility in the region stocks the same set of items). The model 128, once generated, can be deployed to each of the client devices 108 for presentation of recommended item sets at the client devices 108. Deployment of the model 128 to the client devices 108 can enable the client devices to determine recommendations locally, reducing computational burden on the server 104.

The server 104 can also, in some examples, store a list 132 of primary item identifiers. As discussed below, the item sets defined in the repository 124 can each include a primary item identifier (e.g., a base ingredient in a dish, and/or an ingredient that distinguishes the dish from others), and one or more other, non-primary, item identifiers. Invocation of the model 128 in the system 100 is controlled in part by whether or not a customer has retrieved a primary ingredient. The list 132 of primary items can be omitted in some examples, as the primary items are also identified in the repository 124. Provision of the list 132, and in some examples deployment of the list 132 to the client devices 108 along with the model 128, may increase the computational efficiency with which item set recommendations can be generated.

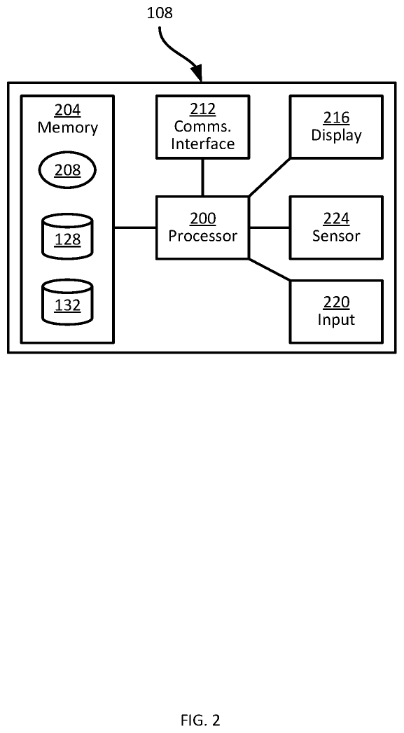

Turning to FIG. 2, certain components of an example client device 108 are illustrated. Each client device 108 deployed in the system 100 includes the components shown in FIG. 2, although the specific instances of the illustrated components need not be identical between client devices 108.

In the illustrated example, the client device 108 includes a processor 200 (e.g., a central processing unit (CPU), graphics processing unit (GPU), or the like), interconnected with a non-transitory computer readable storage medium, such as a memory 204. The memory 204 includes a suitable combination of volatile memory (e.g., Random Access Memory or RAM) and/or non-volatile memory (e.g., read only memory or ROM, Electrically Erasable Programmable Read Only Memory or EEPROM, flash memory). The processor 200 and the memory 204 each comprise one or more integrated circuits. The memory 204 stores computer readable instructions executable by the processor 200 to perform various functionality. In particular, the memory 204 stores an item set recommendation application 208 executable by the processor 200 to perform various actions discussed herein. The memory 204 also stores, in this example, the model 128 and the list 132 mentioned in connection with FIG. 1. For example, prior to or at the time of deployment of the client device 108 to a facility, the client device 108 can be provided with a copy of the model 128 corresponding to that facility, geographic region, or the like, as well as with the list 132.

The client device 108 also includes a communications interface 212 interconnected with the processor 200. The communications interface 212 includes suitable hardware (e.g. transmitters, receivers, network interface controllers and the like) allowing the client device 108 to communicate with other computing devices—e.g., the server 104.

The client device 108 also includes, in the illustrated example, an output such as a display 216, and an input 220 such as a touch screen integrated with the display 216. The client device 108 can include other inputs and/or outputs in other examples, including microphones, speakers, and the like. The client device 108 further includes a data capture sensor 224, such as a camera, a barcode scanner, a radio frequency identification (RFID) reader, or the like. The sensor 224 is controllable by the processor 200 to capture item identifiers from items in the facility, e.g., by reading RFID tags affixed to the items, scanning barcodes on the items, or the like.

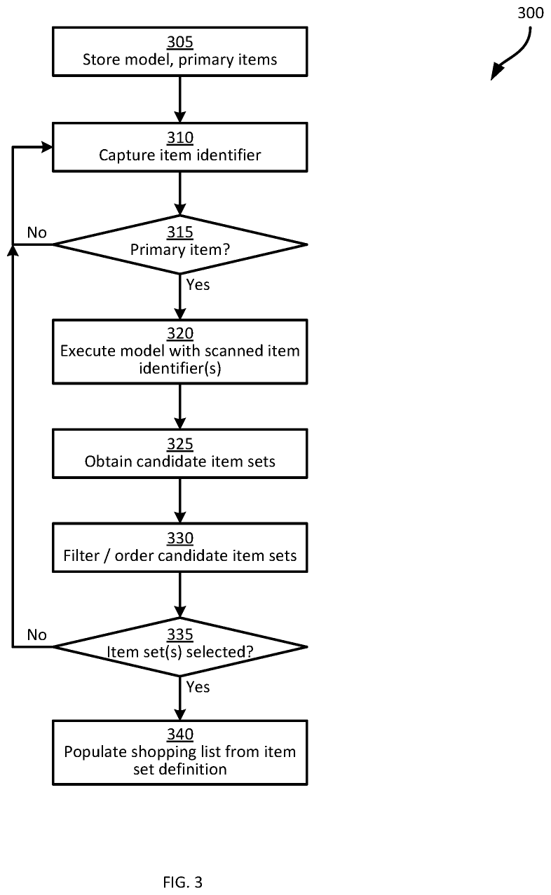

Turning to FIG. 3, a method 300 of generating item set recommendations is illustrated. The method 300 will be described in conjunction with its performance within the system 100, and in particular by a client device 108, e.g., via execution of the application 208 by the processor 200. For example, the client device 108 can be configured to initiate performance of the method 300 in response to activation by a customer at the facility in which the client device 108 is deployed. Activation can include, for example, removal of the client device 108 from the cradle 116.

At block 305, generally prior to activation of the client device 108, the client device 108 is configured to receive and store the model 128, and the list 132 of primary items, if the list 132 is implemented. The model 128 and the list 132 can be received from the server 104, e.g., when the client device 108 is first deployed and/or when the model 128 or the list 132 are updated periodically at the server 104.

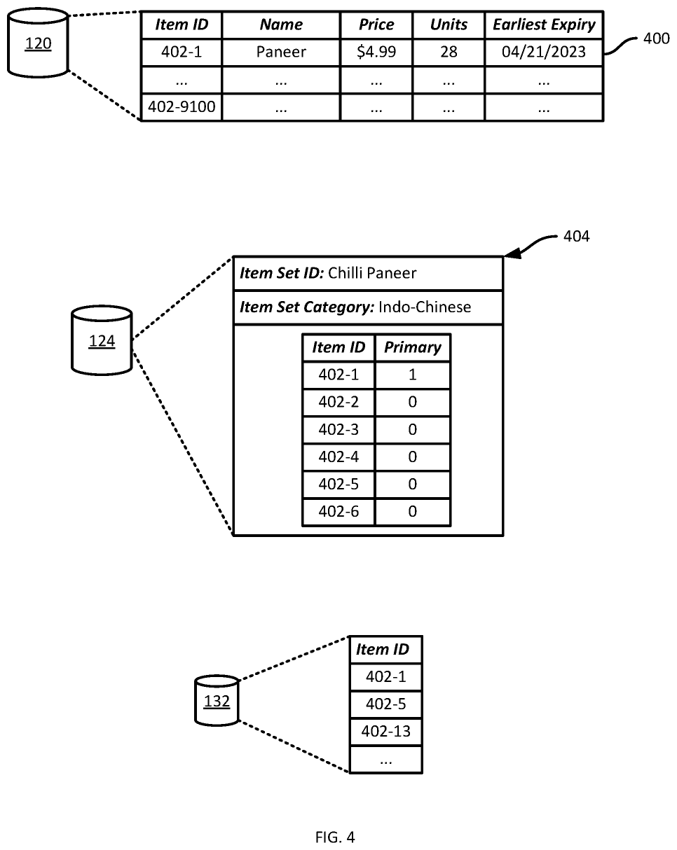

Turning to FIG. 4, partial example contents of the list 132, as well as the repository 124 and the database 120 are illustrated. For example, the database 120 can contain a plurality of records 400, each corresponding to a particular item in the facility. It will be understood that the facility may contain a plurality of instances of each item. That is, an item such as a box of cereal of a particular brand may be represented in the database 120 by one record 400, though the facility may contain a plurality of boxes of that particular cereal. Each record in the database 120 can include an item identifier, such as a numeric or alphanumeric identifier that distinguishes the item from others (e.g., that distinguishes the above-mentioned boxes of the same cereal from any other items in the facility). In the illustrated example, the records 400 include item identifiers 402-1, through to 402-9100, indicating that the database 120 defines nine thousand one hundred items. The number of items, and the format of the item identifiers, is solely illustrative, and items may have any of a wide variety of identifiers.

Each record 400 can also include a name of the corresponding item, such as a brand or the like. Each record 400 can further include attributes for the item, such as a price, a number of units of the item currently in stock at the facility, an earliest expiry date from those units, and the like. Various other attributes can also be stored in each record 400, such as promotional pricing, and the like.

The repository 124 can contain a plurality of item set records 404, each including, for example, an item set identifier such as a name of a dish in the illustrated example. Each record 404 can also include an item set category. The item set category, in the illustrated example, is a type of cuisine, and thus serves to categorize the item sets in the repository 124 into a relatively small (compared to the total number of item sets) number of categories. The item set category can also be omitted in other examples, however.

Each record 404 also includes a set of item identifiers, indicating the ingredients for the dish defined by the record 404. The number of item identifiers included in the record 404 can vary depending on the item set defined by the record 404. Each item identifier appearing in the record 404 also appears in the database 120. That is, each record 404 contains a subset of the item identifiers in the database 120. In the illustrated example, the record 404 contains six item identifiers 402-1, 402-2, 402-3, 402-4, 402-5, and 402-6. Certain item identifiers 402 may appear in more than one record 404, and certain item identifiers 402 may appear in no item set records 404. The record 404 can also, in some examples, include quantities associated with each item identifier 402 (e.g., a quantity per person). The item identifiers 402 shown in the record 404 are distinct ingredients for a given dish. In some examples, one row in the item identifier table of the record 404 can include more than one item identifier 402, e.g., defining alternative items (e.g., two brands of the same ingredient).

As also shown in FIG. 4, each record 404 includes a primary indicator associated with one of the item identifiers 402. The primary indicator is a binary flag in the illustrated example (associated with the item identifier 402-1), but can be stored in various other formats in other examples. The primary indicator can be assigned to an ingredient that forms the base of a dish (e.g., the largest component of the dish by mass and/or volume), but can also be assigned to another ingredient, e.g., an ingredient that is used in few other dishes and therefore serves to distinguish one dish from many others. The specific nature of the primary item is not particularly important, in other words. The identification of one item identifier as the primary item identifier in a record 404, regardless of which item identifier 402 that is, facilitates more computationally efficient generation of item set recommendations, as discussed below.

The repository 124 can therefore contain a number of records 404, each for a distinct dish in this example implementation of the system 100. Each record 404 includes an item identifier 402 marked as a primary item. The list 132 contains the item identifiers 402 that are marked as primary items in any of the records 404. Thus, for example, the item identifier 402-1 is stored in the list 132 as a result of being the primary item in the illustrated record 404. The item identifier 402-5, although not marked as primary in the illustrated record 404, may be a primary item in a different item set record. It will therefore be understood that the list 132 can contain a number of item identifiers 402 equal to the number of records 404 in the repository 124. The list 132, however, consumes less storage space than the repository 124, and also than the database 120.

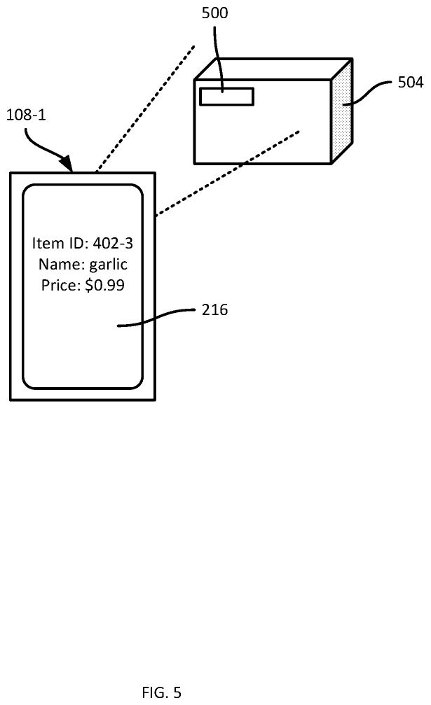

Returning to FIG. 3, at block 310, the client device 108 is configured to capture an item identifier, e.g., via activation of the sensor 224. The sensor 224 can be activated, for example, by an operator of the client device 108 (e.g., a customer) manipulating the input 220 to initiate a barcode scanning operation, an RFID tag read, or the like. Turning to FIG. 5, the client device 108-1 is shown during a performance of block 310, in which the sensor 224 captures a barcode 500 affixed to an item 504. In response to capturing the item identifier (402-3, in this example), the item identifier can be presented on the display 216, along with other data retrieved by the client device 108-1 from the database 120. For example, the client device 108-1 can request item information from the server 104 by sending the item identifier 402-3 to the server 104. The server 104 can retrieve the record 400 corresponding to the item identifier 402-3 from the database 120, and return at least a portion of the record 400 to the client device 108-1 for presentation on the display 216.

Referring again to FIG. 3, at block 315 the device 108-1 is configured to determine whether the item identifier from block 315 matches one of the primary item identifiers in the list 132. The determination at block 315 includes determining whether the item identifier 402-3 appears in the local copy of the list 132 stored in the memory 204. In the present example, the determination at block 315 is negative, and the client device 108 therefore returns to block 310, to await further item identifiers. In other words, under certain circumstances, the client device 108 does not initiate execution of the model 128 to generate item set recommendations.

The determination at block 315 can also include, in some examples, a determination of whether a threshold number of items have been scanned via block 310. For example, the client device 108 can make a negative determination at block 315 even when the scanned item does appear in the list 132, if fewer items have been scanned than a threshold (e.g., three items). Once the threshold number of items have been scanned, and at least one of the captured item identifiers appears in the list 132, the determination at block 315 is affirmative.

When the determination at block 315 is affirmative, the client device 108-1 proceeds to block 320. At block 320, the client device 108-1 is configured to execute the model 128 using the item identifiers obtained via one or more performances of block 310 (any number of such performances, until the affirmative determination at block 315). In some examples, at block 320 the client device 108-1 is configured to execute the local copy of the model 128 stored in the memory 204. In other examples, the client device 108-1 can send a request for model output to the server 104, e.g., including the previously scanned item identifiers.

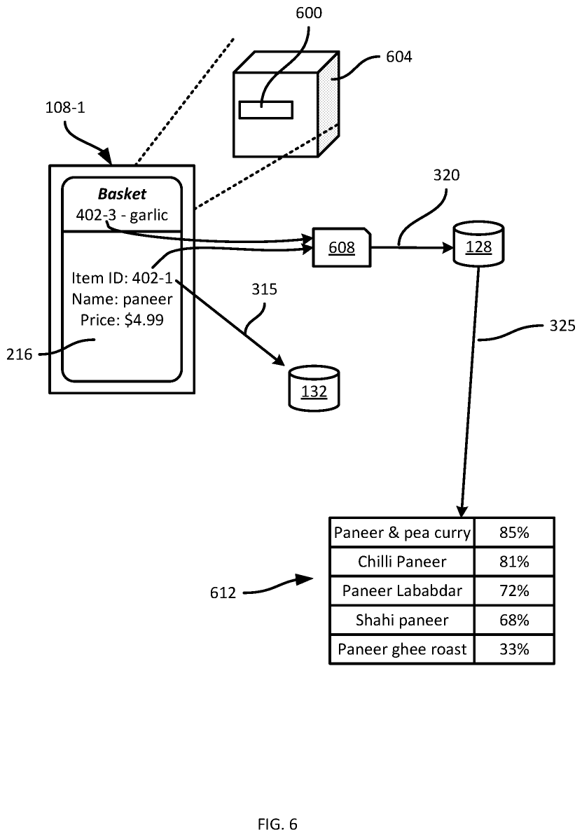

For example, turning to FIG. 6, a further performance of block 310 is illustrated, in which the item identifier 402-1 is captured from a barcode 600 affixed to an item 604. The item identifier 402-1 is present in the list 132, and the determination at block 315 is therefore affirmative. The client device 108-1 therefore provides the model 128 (e.g., by executing the local copy of the model 128, or by sending a request to the server 104) with input data 608 including both the item identifier 402-1, and the previously captured item identifier 402-3. In some examples, the client device 108-1 can prompt the operator, via the display 216, for an item set category, such as a type of cuisine. In such examples, an item set category selected by the operator is also provided in the input data 608. The prompt for item set categories can also be implemented at the time the device 108-1 is activated, e.g., before block 310.

Execution of the model 128 based on the input data 608 results in the client device 108-1 obtaining at least one item set identifier corresponding to an item set containing at least the item identifier from the input data 608 that lead to the affirmative determination at block 315 (that is, the captured primary item identifier). The model 128, as noted earlier, is configured to predict which item set(s) from the sets defined by the records 404 of the repository 124 are most likely to be selected by the operator of the client device 108-1, based on the items identified in the input data 608.

Responsive to providing the input data 608 to the model 128, the client device 108-1 is configured to obtain candidate item sets from the model 128 at block 325. The model 128 can, as illustrated in FIG. 6, generate scores such as confidence levels (shown in percentages in FIG. 6) for some or all of the item set definitions in the repository 124. The item sets with scores greater than a threshold (e.g., 25% in this example), or a predefined number of item sets (e.g., the top five scored item sets) can be selected as candidate item sets. The model 128 thus selects item set candidates 612 from the repository 124. The confidence levels or other scores associated with the candidate item sets 612 indicate the likelihood that, having scanned the item identifiers 402-1 and 402-3, the customer operating the client device 108-1 will select the corresponding item set among the candidates 612.

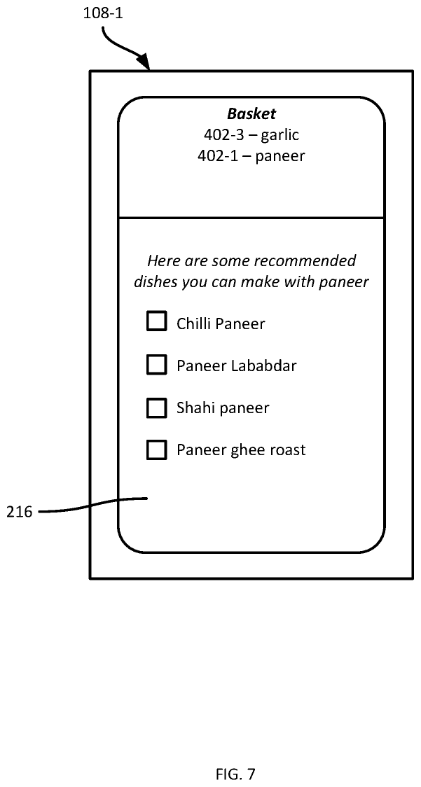

In response to obtaining the item set candidates 612, the client device 108-1 can be configured to present the candidates 612 on the display 216. The client device 108-1 can also, however, be configured to filter and/or rank the candidates 612 at block 330, based on data in the database 120. For example, at block 330 the client device 108-1 can be configured to send a request to the server 104 to determine whether the items contained in the candidate item sets 612 are in stock. The server 104 can, for example, receive the item set identifiers corresponding to the candidate item sets 612 from the client device 108-1, retrieve the individual item identifiers from each candidate item set, and determine whether any items are out of stock. The server 104 can return an out of stock indicator to the client device 108-1 if any of the items in the candidate item sets 612 are out of stock, and the client device 108-1 can discard the corresponding candidate item set. For example, turning to FIG. 7, four of the five candidate item sets 612 are presented on the display 216, with the previously top-ranked item set “paneer pea curry” omitted, because one or more ingredients specified in the record 404 for that item set are currently out of stock.

The client device 108-1 can perform various other filtering and ranking actions at block 330. For example, the server 104 can return promotional pricing data, earliest expiry dates, and the like, for each item set in the candidates 612. The client device 108-1 can be configured to re-order the item set candidates 612, for example, to place an item set first if one or more items of that set have active promotional pricing, if one or more items of that set have earliest expiry dates within a threshold future time period (e.g., within the next two days), or the like.

Each of the item sets presented on the display 216 at block 330, as shown in FIG. 7, can be selected (e.g., via check box, radio button, or other suitable selectable element) via the input 220. At block 335, the client device 108-1 is configured to determine whether one or more of the candidate item sets presented at block 330 have been selected. When the determination at block 335 is negative, the client device 108-1 can return to block 310, and await further item identifiers. The process set out above can be repeated following the next item identifier captured at block 310. That is, a new set of recommended item sets can be generated and presented. In some examples, if no recommended item sets (e.g., the candidate item sets 612) are selected at block 335, the recommendation functionality can be disabled. In other examples, the client device 108-1 can have configuration settings in which an operator can disable or enable the recommendation functionality.

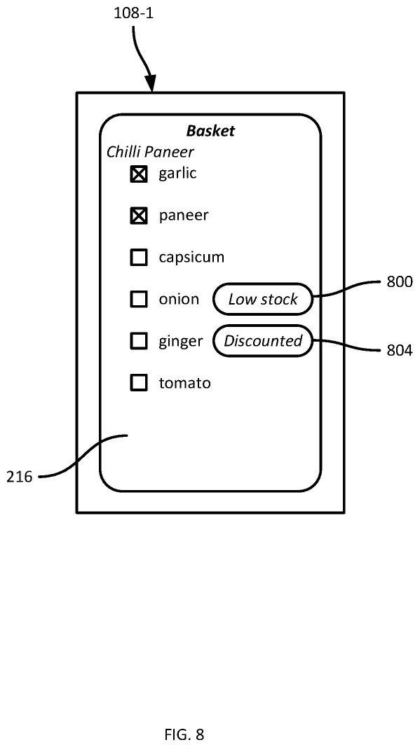

When the determination at block 335 is affirmative, the client device 108-1 proceeds to block 340, and populates a list of target items (e.g., a shopping list) with the remaining items from the selected item set from block 335. That is, the client device 108-1 can present a target list, as shown in FIG. 8, including both the previously scanned items from one or more performances of block 310, and the remaining items from the record 404 corresponding to the selected item set. In the example shown in FIG. 8, the item set “Chilli Paneer” was selected from the interface shown in FIG. 7. Of the six items defined in the corresponding record 404, two were previously scanned, and the remaining four are presented in a target list on the display 216. The two previously scanned items can be marked as already retrieved, e.g., via check boxes or the like. In some examples, the client device 108-1 can obtain (e.g., from the database 120) item attributes indicating that an item is currently discounted, has limited availability, or the like. Those attributes can be presented on the display, e.g., in the form of indicators 800 and 804.

The system 100 therefore facilitates the generation of item set recommendations, based on captured item identifiers, while mitigating the computational load involved in generating such recommendations. The client devices 108 can also be configured to report local activity (e.g., which of the candidate item sets 612 is selected) to the server 104, which can then update (e.g., re-train) the model 128 based on such activity, and deploy an updated model 128 to the client devices 108.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
capturing, via a sensor of a mobile computing device, a first item identifier;
determining, at the mobile computing device, whether the first item identifier matches one of a plurality of primary item identifiers;
in response to determining that the first item identifier matches one of the primary item identifiers, providing input data to a classification model, the input data including the first item identifier;
obtaining, via execution of the classification model, an item set identifier corresponding to an item set containing the first item identifier; and
presenting the item set identifier at an output of the mobile computing device.

2. The method of claim 1, further comprising:
storing, in a memory of the mobile computing device, a list of the primary item identifiers;
wherein determining whether the first item identifier matches one of a plurality of primary item identifiers includes determining whether the list includes the first item identifier.

3. The method of claim 1, further comprising, in response to determining that the first item identifier matches one of the primary item identifiers, prior to providing the classification model with the input data:
capturing, via the sensor, at least one additional item identifier.

4. The method of claim 3, further comprising, prior to providing the classification model with the input data: determining that a count of the first item identifier and the at least one additional item identifier exceeds a threshold.

5. The method of claim 1, further comprising:
in response to presenting the item set identifier at the output, receiving a selection of the item set identifier via an input of the mobile computing device;
retrieving an item set definition corresponding to the item set identifier, the item set definition including at least a second item identifier; and
adding the second item identifier to a list of target items at the mobile computing device.

6. The method of claim 1, wherein obtaining the item set identifier includes obtaining a plurality of item set identifiers corresponding to distinct item sets each including the first item identifier.

7. The method of claim 6, further comprising:
presenting the plurality of item set identifiers at the output.

8. The method of claim 6, further comprising:
for each of the plurality of item set identifiers, querying an inventory repository to determine an availability of a set of items included in the item set; and
when one or more of the set of items is unavailable, discarding the item set identifier without presenting the item set identifier at the output.

9. A computing device, comprising:
a sensor;
a display; and
a processor configured to:
capture, via the sensor, a first item identifier;
determine whether the first item identifier matches one of a plurality of primary item identifiers;
in response to determining that the first item identifier matches one of the primary item identifiers, provide input data to a classification model, the input data including the first item identifier;
obtain, via execution of the classification model, an item set identifier corresponding to an item set containing the first item identifier; and
present the item set identifier at the display.

10. The computing device of claim 9, wherein the processor is further configured to:
store, in a memory of the mobile computing device, a list of the primary item identifiers; and
determine whether the first item identifier matches one of a plurality of primary item identifiers by determining whether the list includes the first item identifier.

11. The computing device of claim 9, wherein the processor is further configured to, in response to determining that the first item identifier matches one of the primary item identifiers, prior to providing the classification model with the input data:
capture, via the sensor, at least one additional item identifier.

12. The computing device of claim 11, wherein the processor is further configured, prior to providing the classification model with the input data, to:
determine that a count of the first item identifier and the at least one additional item identifier exceeds a threshold.

13. The computing device of claim 9, wherein the processor is further configured to:
in response to presenting the item set identifier at the output, receive a selection of the item set identifier via an input;
retrieve an item set definition corresponding to the item set identifier, the item set definition including at least a second item identifier; and
add the second item identifier to a list of target items at the mobile computing device.

14. The computing device of claim 9, wherein the processor is further configured to obtain the item set identifier by obtaining a plurality of item set identifiers corresponding to distinct item sets each including the first item identifier.

15. The computing device of claim 14, wherein the processor is further configured to:
present the plurality of item set identifiers at the display.

16. The computing device of claim 14, wherein the processor is further configured to:
for each of the plurality of item set identifiers, query an inventory repository to determine an availability of a set of items included in the item set; and
when one or more of the set of items is unavailable, discard the item set identifier without presenting the item set identifier at the output.
